(19) United States
(12) Patent Application Publication
(10) Pub. No.: US 2004/0162757 A1
(43) Pub. Date: Aug. 19, 2004

(54) System and method for pay for performance advertising having biddable advertising units utilizing rotating routing to advertiser websites

(76) Inventors: Craig Allen Pisaris-Henderson, Fort Myers, FL (US); Anthony Albert Garcia, Fort Myers, FL (US); Phillip Ross Thune, Bonita Springs, FL (US); Jason Benhard Williams, Cape Coral, FL (US); David Clouston Rae, Naples, FL (US); Peter Thomas Neumann, Fort Myers, FL (US); Sean Patrick Hart, Cape Coral, FL (US); Robert Llewellyn Protheroe, Naples, FL (US)

Correspondence Address: BAKER & BOTTS, 30 ROCKEFELLER PLAZA, NEW YORK, NY, 10112

(21) Appl. No.: 10/724,546

(22) Filed: Nov. 26, 2003

Related U.S. Application Data
(60) Provisional application No. 60/429,494, filed on Nov. 27, 2002.

(51) Int. Cl. G06F 17/60

(52) U.S. Cl. 705/14

(57) ABSTRACT

A computer system and method for a pay for performance advertising system which comprises an account database maintained in computer readable media, the account database comprising a plurality of advertising accounts having funds associated therewith. The computer system further comprises an advertiser database maintained in computer readable media, the advertiser database comprising an advertising unit associated with one or more participating advertisers and bid denominations associated with the participating advertisers. The computer system also comprises a query processing section operatively coupled to the advertiser database. The query processing section is programmed to retrieve, responsive to an advertising unit selection entered on a query client computer, a next advertiser in a rotation of participating advertisers associated with the advertising unit, based on the bid denominations of the participating advertisers, and to route the query client to an advertising content page associated with the next advertiser in the rotation of participating advertisers retrieved by the query processing section.

### CROSS-REFERENCE TO RELATED APPLICATIONS

This present application claims the benefit of U.S. Provisional Application entitled “System and Method For Pay For Performance Advertising Having Biddable Advertising Units Utilizing Rotating Routing To Advertiser Websites” which was filed on Nov. 27, 2002 and assigned Serial No. 60/429,494, which is incorporated by reference in its entirety herein.

### BACKGROUND

1. Field of the Invention

The present invention relates generally to the field of marketing via a computer network using a pay for performance search database. More particularly, the present invention relates to systems and methods for pay for performance advertising having biddable advertising units utilizing rotating routing to advertisers websites.

2. Background of the Invention

The Internet has quickly grown from an obscure resource for high-level researchers to a ubiquitous resource having hundreds of millions of pages of content which is accessible by millions of users. To locate and access specific information of interest within this vast collection of distributed content, various search engines exist which query the pages of content on a continuous basis and generate a searchable database in which the various pages of content are listed. A user desiring access to content can enter a set of search terms in a search engine which are believed to be relevant to the desired content. A list of content pages, also called listings, which match some relevancy criteria is provided by the search engine in response.

There are numerous search engines, such as www.excite.com, www.yahoo.com, www.altavista.com and www.google.com, which provide such services. While the particulars of each search algorithm differ, each of these search engines provide results which are listed by some algorithmically determined relevancy measure.

As an alternative to the computer generated relevancy measure which is provided by a number of conventional search engines, some search engines, such as www.findwhat.com, provide a pay for placement feature which effects where particular content will be listed in response to a user search. In this pay for placement model, advertisers pay a bid amount for certain keywords which are expected to be relevant to the goods and services offered on the content pages they provide. If a user's search includes a keyword which has been purchased by one or more advertisers, these content pages will be listed with a higher priority, in descending order, starting from the highest bidding advertising. Advertisers pay the bid amount of the keyword search term when a user clicks on the displayed title and description for the listing, which provides a hypertext link to the associated content. Therefore, this pay for placement model can also be called a pay for performance (PFP) model.

To list an advertisement with a PFP service provider, advertisers submit their listing entries for inclusion in the PFP database. Each entry generally includes associated content, a title and description which are generally displayed in the search results list, and a keyword search term on which the advertiser indicates bid amount. While some systems restrict the number of keyword search terms to one per entry, others allow multiple. A PFP service provider establishes a base of advertising clients having listing arrangements with the provider. The provider can distribute the listings through search functionality provided on their own webpage or on the webpages of affiliates or distribution partners of the provider. These PFP listings can be merged with the results from a generic search engine database with placement priority given to the PFP listings.

Alternatively or additionally to search based content access, many websites provide access to content through advertisement units, or ad units, which provide a brief advertisement and a hyperlink to associated content. Where such ad units relate to the content of interest for users, they can provide such users with more rapid access to desired content than that provided by search based access.

Advertisers generally pay website providers for ad units based on the size of the ad unit, the number of times the ad unit is displayed to users (cost-per-thousand impressions, CPM), the number of times specified actions result from the presentation of the ad to users (cost-per-action, CPA) or the number of users accessing the advertiser's web page through the ad unit link (cost-per-click, CPC). Current ad units are limited to a single linked advertiser and do not provide participation from a plurality of advertisers. Some webpages have ad units which change, or rotate, over time or webpage access. However some users may find rotation of ad units confusing or distracting. Some PFP advertising systems provide for ad units associated with keyword bids. These ad units are presented in response to a user search query and are another method for displaying search results listings. Such search based ad units require the user to first conduct a search query and then select the ad unit to view desired content.

What is needed is a system and method where non-search based ad units can support biddable participation by advertisers whereby advertisers pay bid amounts when their associated website is accessed by a user selecting the biddable ad unit. Such biddable ad units can be called pay for performance ad units or PFP ad units. Furthermore, it is desirable to have PFP ad units which can support biddable levels of participation from a plurality of advertisers whereby the routing to participating advertisers websites is rotated. Preferably a PFP advertising service can distribute listings from a PFP database in response to user selections of PFP ad units in addition to those distributed in response to user search queries.

### SUMMARY OF THE INVENTION

It is an object of the present invention to provide a system and method whereby an advertiser can bid on and participate in a non-search based biddable ad unit (PFP ad unit) whereby their website is presented in response to a user selecting the ad unit and the advertiser only pays the bid amount upon such selection.

It is a further object of the present invention to provide a system and method whereby a plurality of advertisers can bid on and participate in a PFP ad unit whereby the routing to advertiser websites is rotated. In response to a user selecting the ad unit the user is routed to the next advertiser rotation and said next advertiser pays their bid amount.

It is a further object of the present invention to provide a PFP ad unit system and method which can route a user to a bidding advertiser website, on a rotational basis with other bidding advertiser websites, when said user selects a main portion of the ad unit and can display a set of associated listings from at least a portion of all bidding advertisers in response to a user selecting a predetermined section of the ad unit.

It is a further object of the invention to provide a system and method for determining a rotation of routings to bidding advertiser websites for use in PFP ad units.

It is a further object of the present invention to provide a system and method whereby a PFP database can be distributed in response to both user search queries and ad unit selections.

It is a further object of the present invention to provide a system and method whereby advertisers can specify varying bid amounts for the same keyword and associated advertiser website, for a plurality of ad units and search distribution channels.

These and other aspects of the invention are realized by a computer system for a pay for performance advertising system which comprises an account database maintained in computer readable media, the account database comprising a plurality of advertising accounts having funds associated therewith. The computer system further comprises an advertiser database maintained in computer readable media, the advertiser database having an advertising unit identifier associated with an advertising unit displayable on a website and the advertising unit identifier further associated with one or more participating advertisers and bid denominations associated with the participating advertisers. The computer system also comprises a query processing section operatively coupled to the advertiser database. The query processing section is programmed to retrieve, responsive to an advertising unit selection entered on a query client computer, a next advertiser in a rotation of participating advertisers associated with the advertising unit, based on the bid denominations of the participating advertisers, and to route the query client to an advertising content page associated with the next advertiser in the rotation of participating advertisers retrieved by the query processing section.

According to an exemplary embodiment of the invention, the query processing section may be programmed to determine the next advertiser in the rotation of participating advertisers based on historical rotation data of participating advertisers which may have been previously retrieved by the query processing section and the bid denomination of the participating advertisers. The query processing section may be programmed to determine the next advertiser to reduce a disparity between historical rotation data of the participating advertisers and the relative bid denominations of the participating advertisers. For example, the query processing section may be programmed to determine historical rotation data comprising actual participation data of each of the participating advertisers. Actual participation data may be determined based on a count of the number of times that each participating advertiser is retrieved by the query processing section. The query processing section may be programmed to determine target participation data for each of the participating advertisers based on the respective bid denominations. In an exemplary embodiment, participating advertisers have larger bid denominations would be allocated greater target participation levels than participating advertisers having smaller bid denominations. The query processing section may be programmed to determine the next advertiser in the rotation of participating advertisers by reducing the disparity between the actual participation data and the target participation data of each of the participating advertisers.

According to another exemplary embodiment of the invention, the query processing section may be programmed to determine the next advertiser based on a random number and the bid denomination of the participating advertisers. The query processing section may further comprise a random number generator programmed to generate a random number which is scaled to the range of the sum of the bid denominations of the participating advertisers, and wherein each participating advertiser is associated with a subset of the range corresponding to the respective bid denomination of the respective participating advertiser. The query processing section may be programmed to determine the next advertiser based on a correlation between the random number and the subset of the range corresponding to one of the participating advertisers.

According to yet another embodiment, the query processing section may be programmed to display, responsive to an advertising unit selection entered on a query client computer, a listing of a subset of participating advertisers associated with the advertising unit. Alternatively, the query processing section maybe programmed to display a listing of all participating advertisers associated with the advertising unit. The query processing section may be programmed to display the listing in an order corresponding to the bid denominations associated with the participating advertisers.

A method for providing a pay for performance advertising system on a data network is provided comprising maintaining on a computer system having an account database maintained in computer readable media, the account database comprising a plurality of advertising accounts having funds associated therewith and an advertiser database maintained in computer readable media, the advertiser database having an advertising unit identifier associated with an advertising unit displayable on a website and said advertising unit identifier further associated with one or more participating advertisers and bid denominations associated with the participating advertisers. The method further comprises receiving an advertising unit selection entered on a query client, retrieving, responsive to the advertising unit selection, a next advertiser in a rotation of participating advertisers associated with the advertising unit, based on the bid denominations of the participating advertisers, and routing the query client to an advertising content page associated with the next advertiser in the rotation of participating advertisers retrieved by the query processing section.

According to another exemplary embodiment, the method may further comprise debiting the next advertiser retrieved in the step of retrieving based on the bid denomination in the advertising keyword database.

According to another exemplary embodiment, the step of retrieving may comprise determining the next advertiser in the rotation of participating advertisers based on historical rotation data of participating advertisers previously retrieved in the step of retrieving and the bid denomination of the participating advertisers. The step of retrieving may comprise determining the next advertiser to reduce a disparity between historical rotation data of the participating advertisers and the bid denomination of the participating advertisers. Determining historical rotation data may comprise actual participation data of each of the participating advertisers. The step of retrieving may comprise determining actual participation data based on a count of the number of times that each participating advertiser is retrieved in the step of retrieving.

The step of retrieving comprises determining target participation data for each of the participating advertisers based on the respective bid denominations. The next advertiser in the rotation of participating advertisers may be determined by reducing the disparity between the actual participation data and the target participation data of each of the participating advertisers.

According to another exemplary embodiment, the step of retrieving may comprise determining the next advertiser based on a random number and the bid denomination of the participating advertisers. The method may further comprise generating a random number scaled to the range of the sum of the bid denominations of the participating advertisers, and associating each participating advertiser with a subset of the range corresponding to the respective bid denomination of the respective participating advertiser. The step of retrieving may comprise determining the next advertiser based on a correlation between the random number and the subset of the range corresponding to one of the participating advertisers.

According to a further exemplary embodiment, the method may further comprise displaying, responsive to an advertising unit selection entered on a query client computer, a listing of all, or alternatively, subset of participating advertisers associated with the advertising unit. The listing may be displayed in an order corresponding to the bid denominations associated with the participating advertisers.

In accordance with the invention, the objects described above have been met, and the need in the art for a system and method where non-search based ad units can support biddable participation by advertisers has been met.

### BRIEF DESCRIPTION OF THE DRAWING

FIG. 1 is a simplified block diagram of a system for practicing the present method of PFP advertising having biddable ad units utilizing rotating routing to advertiser websites;

FIG. 2 is an illustration of an exemplary website screen display for a PFP distribution website provider having a search query box and ad units;

FIG. 3 is a flowchart illustrating a transaction flow for a search query and response initiated by a client of a website provider;

FIG. 4 is a flowchart illustrating a transaction flow for an ad unit selection, rotation and response initiated by a client of a website provider;

FIG. 5A is a pictorial representation of an exemplary ad unit bid profile;

FIG. 5B is a pictorial representation of a bid weighted measured rotation for the bid profile of FIG. 5A;

FIG. 5C is a pictorial representation of a range assignment for a bid weighted random rotation for the bid profile of FIG. 5A;

FIG. 6 is an illustration of an exemplary bid manager screen display which can be used to manage bid amounts for search queries and ad units.

### DETAILED DESCRIPTION OF PREFERRED EMBODIMENTS

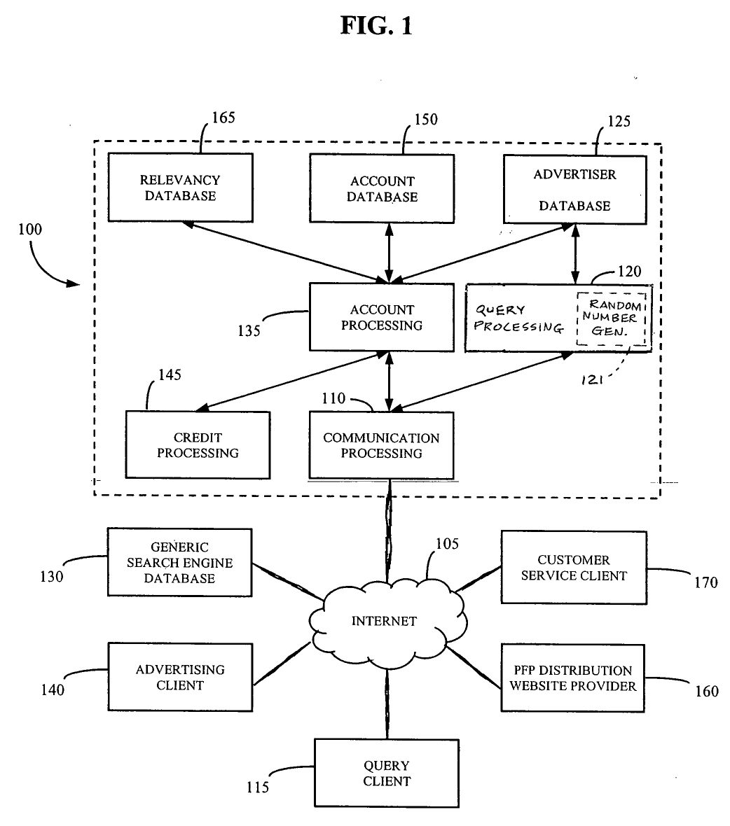

FIG. 1 is a simplified block diagram of a pay for performance advertising system having biddable advertising units in accordance with the present invention. The system includes a server 100 which is operatively coupled to a data network 105, such as the Internet, via appropriate communication processing and I/O circuitry 110 which are well known in the art. The server 100 maintains the PFP database, performs query processing and also performs account processing functions.

A query client 115 is associated with a PFP distribution website provider 160 which is operatively connected to the server 100 and client 115 via the network 105. The server 100 may also be a distribution website provider and the query client 115 can be associated thereto. The distribution website provider 160 can provide content of interest to query client 115 and may include PFP search functionality and/or PFP ad units on their websites.

In query processing, when a keyword search query is entered by the query client 115, which is a remote computer, network appliance or set top box, coupled to the server 100 via the Internet 105, the communication processing block 110 passes the search query to a query processing section, or query processing block 120. The query processing block 120 submits the search query to both a proprietary PFP advertiser database 125 in the server 100 and a generic search engine database 130 via the Internet 105.

The generic search engine database 130 can take the form generally known in the art which are generated by various web crawler and web spider techniques, such as the database offered by Inkotomi. The query processing block 120 can receive relevant responses to the keyword search query from both the generic search engine database 130 and from the advertiser database 125 maintained in computer readable media. The results may be merged by the query processing block 120 with the results from the advertiser database 125 having priority over the results from the generic search engine database 130. The results from the advertiser database 125 are further sorted in descending order based on a denomination associated with the keyword in the advertiser database, which is generally a cash amount paid per “click through” by advertisers purchasing the keywords. In this way, the advertiser database is a PFP database.

Each PFP ad unit is displayable on a website, and has an identifier, e.g., a unique ID or code associated with it. In PFP ad unit processing, when a PFP ad unit is selected by a query client 115, which may be a remote computer, network appliance or set top box, coupled to the server 100 via the Internet 105, the communication processing block 110 passes the ad unit identifier associated with the selected ad unit to a query processing block 120.

Responsive to the selection from the query client computer, the query processing block 120 retrieves the next advertiser. Following the selection at the query client computer, the query processing block 120 may access the advertiser database 125. The advertiser may include records associating particular ad unit identifiers with participating advertisers, the location of the selected content, which is generally specified as a network address or uniform resource locator (URL), and bid denominations associated with the particular advertisers. The query processing block determines a set of advertisers participating in the selected ad unit and further determines the next advertiser in a rotation of the set of advertisers. Alternatively, as discussed above, the next advertiser may have been previously selected. In such a case, the query processing block 120 may skip the steps of determining the set of advertisers participating in the selected ad unit and determining the next advertiser in a rotation of the set of advertisers. The query processing block 120 then routes the query client 115 to the associated website of the next advertiser.

The server 100 includes an account processing block 135. The account processing block 135 is coupled to advertising clients 140 via the Internet 110 and allows advertisers to submit listings, bid for various keywords for both search queries and ad units, open payment accounts, and access keyword performance data. The account processing block 135 is coupled to a credit processing block 145 which communicates with remote credit providers to establish an advertiser account. To open an account, a prospective advertising client 140 provides accessible credit information, such as credit card, debit card, or online account information to the server 100 which authenticates the credit information and effects a fund transfer from the remote credit account to an advertiser account stored in an account database 150. The account database 150 is maintained in computer readable media.

A listing submitted by advertising clients 140 may include, e.g., a title, a description, a link to associated content pages and at least one keyword, each of the at least one keyword having an associated bid amount. Controlling listings in the advertiser database 125 to insure a high degree of relevancy provides for relevant search results to search queries. Prior to adding the submitted listing in the advertiser database 125, the account processing block 135 can verify relevancy among keywords, the title, the description, and the associated content pages. Account processing block 135 accesses a relevancy database 165 to make a relevancy determination and/or customer service client 170, which is coupled to the server 100 via the Internet 105 or other network connection for manual relevancy processing by a customer service representative.

Since it is undesirable for a user attempting a search query to receive a result list containing redundant listings from the same advertiser, duplicate listings are also controlled by the account processing block 135. The account processing block 135 can compare the submitted listing to other listings for the advertiser contained in the advertiser database 125 to make a duplicate listing determination and/or can access the customer service client 170 for manual processing of duplicate listings by a customer service representative.

While only one advertising client 140, one query client 115, one PFP distribution website provider 160 and one customer service client 170 are shown in FIG. 1, many are possible.

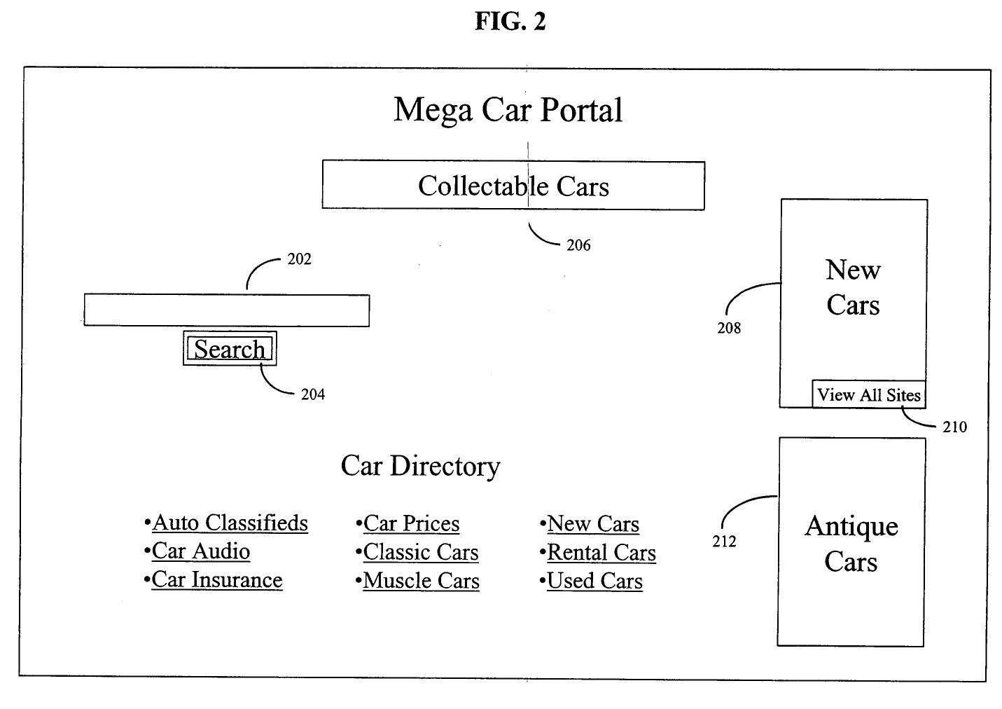

FIG. 2 is an illustration of an exemplary website screen display for a PFP distribution website provider having a search query box 202 and ad units 206, 208 and 212. Query client 115 can perform a keyword search, e.g., by entering a search term in search box 202 and selecting a search button 204 to submit a search query and receive a results list of listings. Query client 115 can select an ad unit, e.g., ad units 206, 208 and 212, and be routed to one or more websites associated with the selected ad units. The PFP ad units may have more than one associated website. One or more advertisers may participate in the PFP ad unit, for example, by associating listings and providing bid amounts. When query client 115 selects a PFP ad unit, the next advertiser is retrieved from the participating advertisers. The next advertiser and associated website to which the query client 115 is to be routed may be determined at the time of the selection by the query client or earlier, and the query client is routed to the associated website of the next advertiser, who pays the bid amount associated with the ad unit. Ad unit 208 may optionally include a section 210 which can be selected to view at least a portion of all listings associated therewith. In response, the server 100 will return the associated advertiser listings, or portion thereof, in a result list ordered by associated bid denomination. In an exemplary embodiment of the invention, the query processing block 120 will return the associated advertiser listings. If the query client 115 selects one of the listings in the results list, the retrieved advertiser pays the bid amount associated with the ad unit.

PFP ad units 208 and 212 can be created by a variety of participants in the PFP service. For example, the PFP service provider can create PFP ad units 208 and 212 and market them to PFP distribution website providers 160 as a method to generate additional PFP revenue from their websites. Alternatively, PFP distribution website providers 160 can create PFP ad units 208 and 212 and submit them to the PFP service provider for inclusion in the advertiser database 125. PFP ad units are associated with the PFP distribution website provider 160.

PFP ad units 208 and 212 can have a keyword associated with them to facilitate the bidding process. Advertisers 140 which have a listing having the same keyword associated thereto can be provided with the option to bid on the ad unit. For example, ad unit 208 can have the keyword NEW CARS associated with it. Ad unit 212 can have the keyword ANTIQUE CARS associated with it. Advertisers having a listing with the keyword NEW CARS can be given the option to bid on ad unit 208. Advertisers having a listing with the keyword ANTIQUE CARS can be given the option to bid on ad unit 212. Alternatively, ad units 208 and 212 can have a product, service or vertical industry associated with them. For example, ad units 208 and 212 can have the service AUTOMOBILE SALES associated with them. Advertisers offering the service AUTOMOBILE SALES can be provided with the option of bidding on ad units 208 and 212.

The graphical representation of ad units 208 and 212 do not need to be stored in the advertiser database 125. (Another embodiment, in which the graphical representation is stored in the advertiser database, is discussed below.) Ad unit identifiers can be used to support the association of bids to ad units 208 and 212, the association of queries to ad units 208 and 212, and the retrieval of the graphical representation of ad units 208 and 212 for review by an advertiser contemplating bidding on one or both of the ad units 208 and 212.

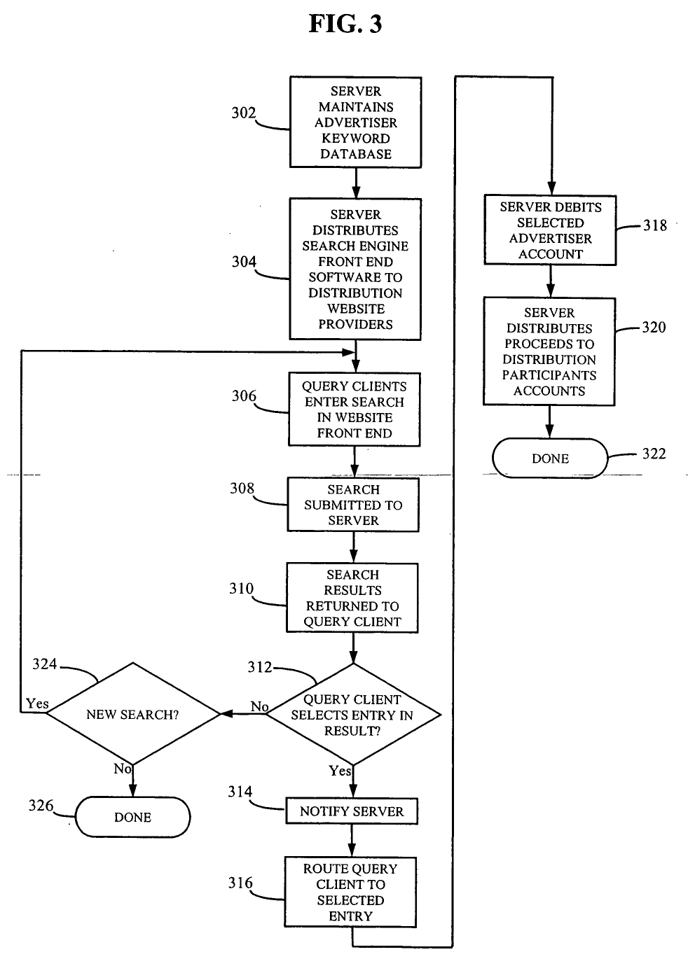

FIG. 3 is a flow chart which illustrates the interaction between the server 100, PFP website provider 160 and query client 115 in response to a search query transaction. As illustrated in FIG. 1, the server 100 maintains an advertiser database 125 (step 302). In this database, the server 100 stores listings which include keywords along with associated denominations, or bid amounts, for the keywords. Listings can have bid amounts associated with each of a plurality of search distribution channels. Search distribution channels consist of one or more PFP distribution website providers 160. Distribution channels may have search based keyword bids and ad unit based keyword bids associated therewith. The advertisers 140 can review the advertiser database 125 with respect to the various search distribution channels to determine their placement in searches which include particular search terms originating from the distribution channels with which they have listings associated. To determine their placement, advertisers 140 compare the bid price they are willing to pay when a client 115 selects their listing as compared to competitive bid prices for the same keyword. The advertisers 140 can also review the advertiser database 125 to determine their level of participation in particular ad units for which they have bids. The server also includes a query processing block 120 which allows ad unit selections to be processed and client queries to be parsed and compared against the advertising keyword database 125 to determine if there is one or more match.

In order to participate in the system, website provider 160 must have appropriate PFP distribution software which provides a search term entry field and/or PFP ad unit functionality to the client computers.

The PFP distribution software is preferably distributed to the website provider 160 by the server 100 via the Internet network connection (step 304). Of course, computer readable media with the distribution software thereon can also be provided to the distribution website provider 160 if desired. The distribution software will present a search term entry field and/or provide PFP ad unit functionality on the website provider 160 Internet content page where the client 115 can enter one or more search terms (step 306).

When the client 115 enters a search term, the distribution software submits the search to the server 100 for query processing (step 308). The search results from the server 100 are then returned to the client 115. Preferably, the search results include both the direct hits in the advertiser database 125 followed by the results from a conventional generic search engine database 130, such as that provided by Inkotomi, Inc (step 310). The results can be provided to the client 115 by passing the data to the website provider 160 or by temporally linking the client 115 to a separate web page provided by the server 100. Generally, the search results take the form of a list of titles and descriptions of relevant content along with a hypertext link to the content. For those results which are provided from the advertiser database 125, an indication of the price paid by the advertiser for such ranking may also be provided.

To select content of interest from the search results, the client 115 selects the entry, such as by clicking on the entry using a graphical user interface (GUI) at the client location. If the query client 115 selects an entry in the search result (step 312), the server 100 is notified of the selection (step 314). The notification can take the form of a message provided by the website provider 160, or can take the form of routing the client 115 through the server 100 or associated redirect computer on the way to the destination of the selected content. In either case, the client 115 will be routed to the location of the selected content, which is generally specified as a network address or uniform resource locator (URL) (step 316).

The notification to the server 100 in step 314 provides an indication of the PFP distribution website provider 160 which referred the client as well as an indication of the content that was selected. From this information, the server 100 can perform account processing 135. The account processing 135 includes debiting the advertiser 140 of the selected content by the denominated bid amount for the client's 115 “click-through” to the advertisers content (step 318). A portion of the proceeds from the advertiser 140, or some other fee arrangement, is attributable to the distribution website provider 160 and/or their associated distribution channel, collectively referred to as distribution participants, as compensation for the referral. Therefore, the account processing 135 also includes crediting the accounts of the distribution participants for the appropriate sum (step 320).

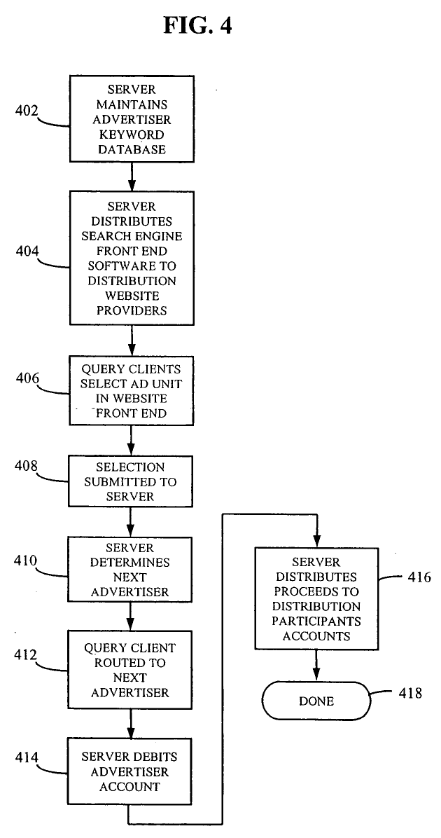

FIG. 4 is a flow chart which illustrates the interaction between the server 100, distribution website provider 160 and query client 115 in response to a PFP ad unit transaction. As previously described in conjunction with FIG. 3, the server 100 maintains an advertiser database 125 (step 402) and distributes PFP distribution software to distribution website providers 160 (step 404).

To view content associated with a PFP ad unit, the query client 115 selects the ad unit (step 406) and the PFP distribution software submits the ad unit selection to the server 100 (step 408). The server 100, e.g., the query processing block 120, then determines the next advertiser rotation (step 410) and routes the query client 115 to the advertiser website (step 412). Account processing 135 includes debiting the advertiser 140 account to which the query client 115 was routed by the associated denominated bid amount (step 414). A portion of the proceeds from the advertiser 140, or some other fee arrangement, is attributable to the distribution website provider 160 and/or their associated distribution channel collectively referred to as distribution participants, as compensation for the referral. Therefore, the account processing 135 also includes crediting the accounts of the distribution participants for the appropriate sum (step 416) and the process terminates in step 418.

PFP ad units may have a plurality of participating advertisers. Advertisers are rotated to enable a plurality of advertisers to participate. Such rotation can be based on the bid amounts of the participating advertisers whereby the higher the bid amount, the higher the level of participation. A method of rotation based on the bid amounts is referred to herein as a “bid-weighted rotation.” The bid weighted rotation can be determined based on historical rotation data in addition to the bid profile (bid weighted measured rotation) or it can be determined as a random number in conjunction with the bid profile (bid weighted random rotation). When a user selects the ad unit, the next advertiser to which the user should be routed is determined. Alternatively, the rotation can be determined prior to the selection of the ad unit. For example, a schedule could be calculated for the next 100 ad unit selections based on the current bid profile for the ad unit. However, since bid changes can be made after the rotation is determined, such prior determination can be rendered inaccurate due to bid changes.

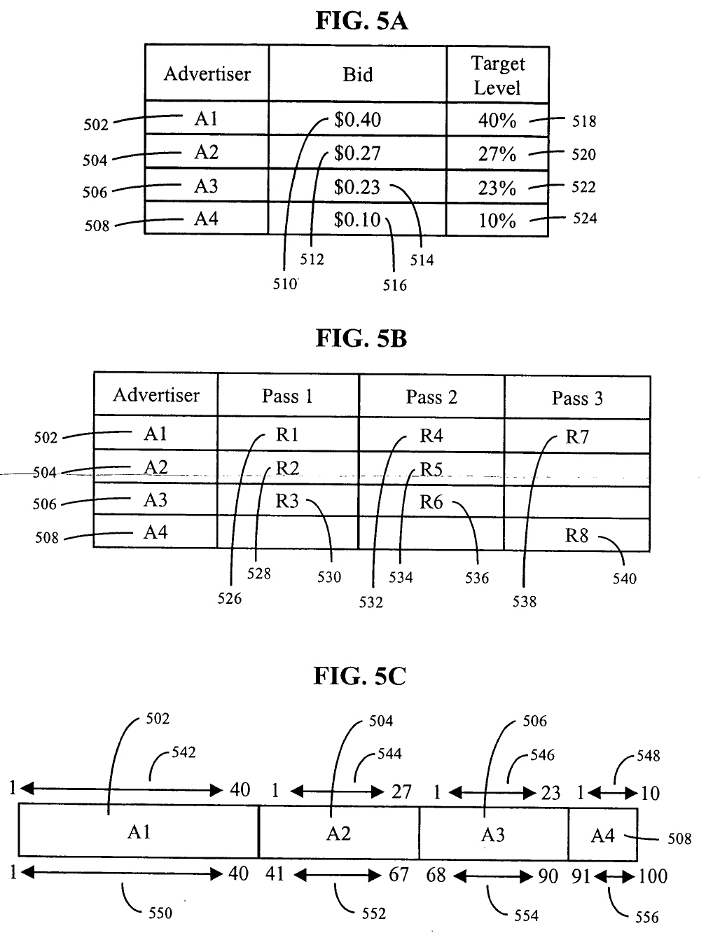

FIG. 5A depicts an exemplary ad unit bid profile for advertisers 502, 504, 506 and 508 each having a bid amount respectively being 510, 512, 514 and 516. The bid profile may be maintained in the advertiser database 125 The target level of participation for each advertiser is based on the relative bid amount when compared with the bids of all participating advertisers. For example, a target percentage level of participation is equal to the bid amount of a participating advertiser divided by the total of the bids amounts for all participating advertisers, multiplied by 100 percentage units. In this example, the total of the bids is equal to $1.00. As such there is a simple correlation between the bid amounts and the target participation levels. Advertisers 502, 504, 506 and 508 have target participation levels 518, 520, 522 and 524 respectively.

For a measured rotation, historical rotation information, e.g., the count of the number of times each advertiser has been presented, is maintained. The total count for the number of times all advertisers have been presented can be maintained or calculated as needed by summing the individual counts. Each time the ad unit is selected, the server 100, or in particular the query processing section, determines if one or more advertiser target participation levels have been met by their actual participation levels, e.g., as indicated by the counts. The server 100 selects the next advertiser in the rotation to reduce any disparity between the target participation level and the actual participation level. For example, the participation levels may be examined, and satisfied in an order starting from the advertiser having the highest target level and going to the lowest target level. This ordering provides examination priority to the advertisers based on participation level. When two or more advertisers have the same bid amount, the order can reflect the length of time each advertiser has maintained their current bid, such that the advertiser having the longest bid duration is examined first.

FIG. 5B shows the results of a set of eight rotations 526, 528, 530, 532, 534, 536, 538, and 540, for the bid profile shown in FIG. 5A. Prior to the first rotation 526, no advertisers have yet been presented. As such, the target level of the highest bidding advertiser 502, has not yet been met and the first rotation 526 is assigned thereto. For the second rotation 528, the participation levels, actual and target, of the highest bidding advertiser 502 are first measured. Advertiser 502 has a count of one for a total count of one and therefore has an actual level of 100% which satisfies the associated target level 518 of 40%. The participation levels of the next highest bidding advertiser 504 are then examined. Advertiser 504 has not been presented and has a participation level of 0% against a target level 520 of 27%. The second rotation 528 is therefore assigned to advertiser 504.

For the third rotation 530, the participation levels of the highest bidding advertiser are first examined and found to be an actual of 50% against a target 518 of 40%. The levels of the next highest bidding advertiser 504 are then examined and found to be an actual of 50% against a target 520 of 27%. The levels of the next highest bidding advertiser 506 are then examined and determined to an actual of 0% against a target 522 of 23%. The third rotation 530 is therefore assigned to advertiser 506.

For the fourth rotation 532, the participation levels of the highest bidding advertiser are first examined and are determined to be an actual of 33.3% against a target 518 of 40%. The fourth rotation 532 is therefore assigned to advertiser 502. This process continues with rotations 534, 536, 538 and 540 being assigned to 504, 506, 502 and 508 respectively, thereby accounting for eight rotations. A calculation at this point reveals that the actual levels for advertisers 502, 504, 506 and 508 are 37.5%, 25.0%, 25.0% and 12.5% respectively, against target levels of 40%, 27%, 23% and 10%. After numerous rotations occur the difference between the actual levels and targets levels becomes small. It is possible for all target levels to be satisfied by the associated actual levels. In this instance, the rotation can be awarded to the highest bidding advertiser.

It is understood that other examination orders than that provided in the foregoing discussion may be used in accordance with the invention, provided that such examination orders provide for a convergence, i.e., a reduction in the disparity, between actual participation levels and target participation levels. Furthermore, the foregoing method for measured rotation has the advantage of providing for a priority examination order of participation levels based on bid amount.

When a new advertiser establishes a bid, new target levels are calculated for each participating advertiser including the new advertiser and the new advertiser is added to the rotation. A count can be assigned to the advertiser. This count can be chosen to establish an actual participation level close to the target level of the advertiser. Alternatively, the new advertiser can assume the count of one of the advertisers adjacent to it in the order of target participation levels. If a separate total count is maintained, it is adjusted up by the count assigned to the new advertiser. When an existing advertiser removes a bid, new participation levels are calculated for the remaining advertisers, the advertiser removing the bid is removed from the rotation, the associated count is deleted, and if a separate total count is maintained it is adjusted down by the deleted count. When a bid changes, it can be treated as a removed bid followed by a new bid for the advertiser changing the bid.

Periodically, as the counts become large they can be scaled down. For example, when the total count exceeds 10,000 or some other predetermined threshold, all counts can be divided by 100 or some other predetermined divisor.

In the foregoing measured rotation method, the step of multiplying the participation levels by 100 percentage points to express them as percentages is not necessary, but merely an exemplary approach and useful in describing the method.

According to another embodiment of the invention, “random rotation” may be provided. In an approach involving random rotation, the query processing block 120 may include a random number generator 121, which generates a random number that may be used to determine the next advertiser in the current rotation. (Random number generator 121 may be selected from random number generators known in the art, such as, for example, random number functions provided in Microsoft C++, C#, and T-SQL.) According to this embodiment, no historical counts are needed. The range of values generated by random number generator 121, e.g., high numerical value through low numerical value, may be scaled to equal the range of the sum of the bids for the bidding advertisers. Accordingly, each advertiser occupies a subset of the scaled range proportional to their respective bid amount. Thus the higher the bid, the “larger” the respective subset of the scaled range of values. Under this approach, the advertiser occupying the subset in which the scaled random number falls is retrieved for the rotation. FIG. 5C illustrates a range assignment for the bid profile of FIG. 5A having a set of absolute range indications 542, 544, 546 and 548 and a set of relative range assignments 550, 552, 554 and 556 for advertisers 502, 504, 506 and 548 respectively. Since the bid 510 for advertiser A1 502 is the largest amount, i.e., $0.40, the relative range assignment 550 is also the largest of the various advertisers represented in FIGS. 5A and 5C.

This approach operates as follows: for a scaled random number generated between 1 and 40, advertiser 502 is retrieved and indicated by range assignment 550. For example, if a scaled random number between 41 and 67 is selected, it falls within range assignment 552. Accordingly, advertiser A2 504 is retrieved. For a scaled random number between 68 and 90, advertiser 506 is retrieved and indicated by range assignment 554. Lastly, for a scaled random number between 91 and 100, advertiser 508 is retrieved and indicated by range assignment 556.

The absolute ranges can be used without the need for assigning relative ranges. This method of random rotation also uses the random number generator scaled to the sum of the bids. The absolute ranges are ordered in size from largest to smallest and are subtracted one at a time from the scaled random number until the result is negative or zero. The advertiser associated with the absolute range which caused the negative or zero result is the advertiser retrieved for the rotation. Alternatively the absolute ranges can be subtracted from the scaled random number until the next absolute range is larger than the remaining scaled random number. The advertiser associated with the next absolute range is the advertiser retrieved for rotation.

The absolute bid ranges need not be ordered and subtracted in order from largest to smallest. However this method has the benefit in that the total range for the scaled random number is traversed as rapidly as possible with each successive arithmetic operation.

In another embodiment, advertising content which is specific to the participating advertiser can be displayed in the biddable advertising unit. In this embodiment, the advertising content for the specific advertiser, or a link thereto, is also contained in the advertiser database 125. The advertising content may include the specific graphical information which is displayed as a graphical representation of the advertising unit itself, substantially as shown at advertising unit 208 in FIG. 2. The adveritising content may include the content of the website associated with the advertiser. When a query client accesses the website page of the PFP distribution website provider which contains the ad unit, a request for the ad unit is sent to the PFP service provider for display of the advertising unit on the query client computer. In response to the advertising unit request, the query processing section determines the next advertiser in rotation and retrieves the associated advertising content for the next advertiser. If the client selects the advertising unit, the query client is routed to the associated website and the advertiser is debited the bid amount. Since the rate of selection of the ad unit can be dependent on the advertiser specific advertising content therein, the method for determining the next advertiser in rotation may further include weighting based on both the bid amount and the rate of selection.

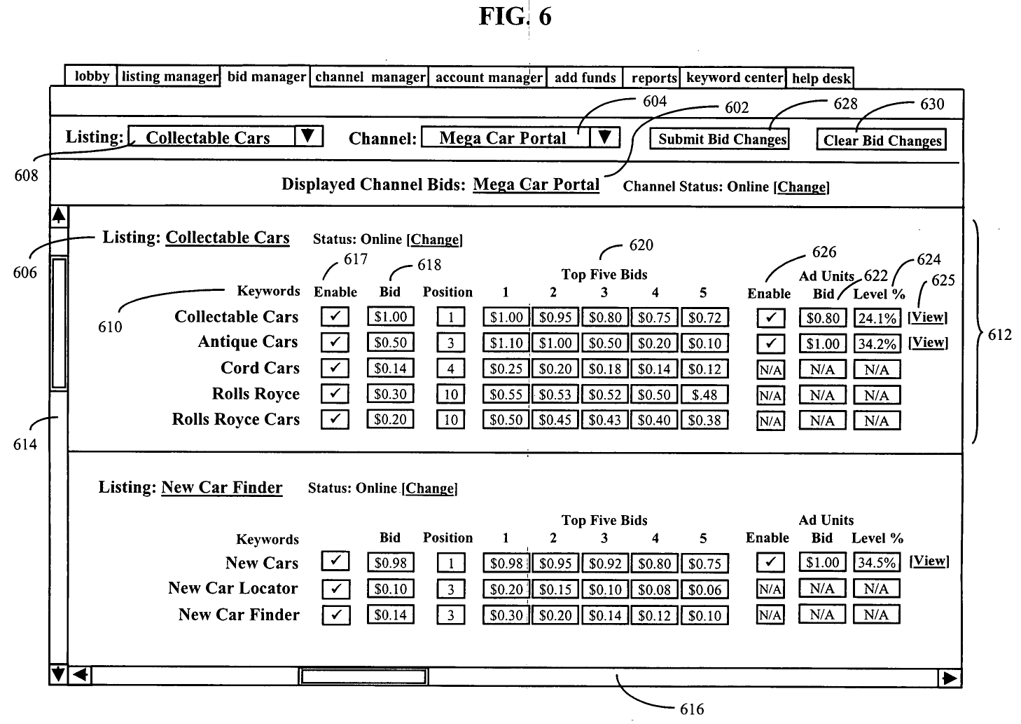

FIG. 6 is an illustration of an exemplary bid manager screen display having bid amounts for search queries and ad units. The computer system, including the bid manager user interface screen of FIG. 6, provides an advertiser with the option to participate in a biddable keyword, and to retrieve a channel 602 corresponding to a distribution website provider 160 (See, e.g., FIG. 1) using a drop down entry box 604 and to select a listing 606 using a drop down entry box 608. A list of keywords 610 associated with listing 606 are displayed in a section 612 of the bid management screen along with bid settings and bid information. Scroll bar 614 enables the advertiser to scroll vertically through additional listings. Alternatively box 608 can be used to move to additional listings. Scroll bar 616 allows the advertiser to scroll horizontally through additional channels. Alternatively box 604 can be used to move to additional channels. Bids for search queries can be entered in bid column 618. An enable column 617 provides advertisers with the option to enable and disable the bids. The advertiser can view the top five bids for the keywords 610 in top five bids column 620.

The account processing section 135 can access the advertiser database 125 to determine if it comprises any ad units associated with the displayed channel 604 which are further associated with a keyword comprised within the displayed listings 610. If there are any such ad units, the account processing section 135 can provide the advertiser with the option to bid on, or participate in, the ad unit. The advertiser can thus create an advertiser listing for distribution in a keyword based search system, which when selected by a query client, routes the query client to the advertiser website associated with the listing, and optionally associates the same advertiser website to a biddable ad unit whereby a query client selecting the ad unit will be routed to the advertiser website, provided the advertiser is next in rotation for the selected ad unit.

An ad units bid column 622 can be used to enter bids for available ad units. Keywords which do not have available ad units for the displayed channel have a “N/A” entered in their ad unit bid location. A view ad unit column 625 can be used to view an available ad unit. This view can also provide advertisers with the URL or a link for the website on which the ad unit is displayed. When a bid is entered into the ad unit bid location, a participation level is calculated and displayed in a participation level column 624. An enable column 626 provides advertisers with the option to participate in a biddable advertising unit to enable and disable the ad unit bids. After changes for bids within a channel are made, the advertiser can select a submit bid changes button 628 to update the channel bids. Upon selecting a clear bid changes button 630, bid changes not yet submitted for the displayed channel will be cleared and the changed bid settings are returned to their previous settings.

The present invention can be applied to selection targets other than ad units displayed on website pages. For example, the present invention can be applied to a textual link on a web page or in an email, or the ad unit can be contained in an email.

Provided the detailed disclosure herein, those skilled in the art may envision how the present invention could be practiced using alternative embodiments and variations thereof. The foregoing detailed description should be regarded as illustrative rather than limiting.

What is claimed is:

1. A computer system for a pay for performance advertising system, the computer system comprising:
an account database maintained in computer readable media, the account database comprising a plurality of advertising accounts having funds associated therewith;
an advertiser database maintained in computer readable media, the advertiser database having an advertising unit identifier associated with an advertising unit displayable on a website and said advertising unit identifier further associated with one or more participating advertisers and bid denominations associated with the participating advertisers;
a query processing section operatively coupled to the advertiser database and programmed to:
retrieve, responsive to an advertising unit selection entered on a query client computer, a next advertiser in a rotation of participating advertisers associated with said advertising unit, based on the bid denominations of the participating advertisers;
route the query client to an advertising content page associated with the next advertiser in the rotation of participating advertisers retrieved by the query processing section.

2. The computer system recited in claim 1, wherein the query processing section is further programmed to determine the next advertiser in said rotation of participating advertisers based on historical rotation data of participating advertisers and the bid denomination of the participating advertisers.

3. The computer system recited in claim 1, wherein the query processing section is further programmed to determine the next advertiser to reduce a disparity between historical rotation data of the participating advertisers and the bid denomination of the participating advertisers.

4. The computer system recited in claim 2, wherein the query processing section is further programmed to determine historical rotation data comprising actual participation data of each of the participating advertisers.

5. The computer system recited in claim 2, wherein the query processing section is further programmed to determine actual participation data based on a count of the number of times that each participating advertiser is retrieved by the query processing section.

6. The computer system recited in claim 2, wherein the query processing section is further programmed to determine target participation data for each of the participating advertisers based on the respective bid denominations.

7. The computer system recited in claim 6, wherein the query processing section is further programmed to determine the next advertiser in said rotation of participating advertisers by reducing the disparity between the actual participation data and the target participation data of each of the participating advertisers.

8. The computer system recited in claim 1, wherein the query processing section is further programmed to determine the next advertiser based on a random number and the bid denomination of the participating advertisers.

9. The computer system recited in claim 8, wherein the query processing section further comprises a random number generator programmed to generate a random number scaled to the range of the sum of the bid denominations of the participating advertisers, and wherein each participating advertiser is associated with a subset of the range corresponding to the respective bid denomination of the respective participating advertiser.

10. The computer system recited in claim 9, wherein the query processing section is further programmed to determine the next advertiser based on a correlation between the random number and the subset of the range corresponding to one of the participating advertisers.

11. The computer system recited in claim 1, wherein the query processing section is further programmed to display, responsive to an advertising unit selection entered on a query client computer, a listing of a subset of participating advertisers associated with said advertising unit.

12. The computer system recited in claim 11, wherein the query processing section is further programmed to display, responsive to an advertising unit selection entered on a query client computer, a listing of all participating advertisers associated with said advertising unit.

13. The computer system recited in claim 11, wherein the query processing section is further programmed to display said listing in an order corresponding to the bid denominations associated with the participating advertisers.

14. A computer system for a pay for performance advertising system, the computer system comprising:
an account database maintained in computer readable media, the account database comprising a plurality of advertising accounts having funds associated therewith;
an advertiser database maintained in computer readable media, the advertiser database comprising an advertising unit identifier associated with an advertising unit, said advertising unit identifier further associated with one or more participating advertisers, and bid denominations and advertising content associated with each participating advertiser; and
a query processing section operatively coupled to the advertiser database and programmed to retrieve, responsive to a request for an advertising unit for display on a query client computer, a next advertiser and advertising content associated with the next advertiser in a rotation of participating advertisers associated with said advertising unit, based at least in part on the bid denominations of the participating advertisers.

15. The computer system recited in claim 14, wherein the query processing section is further programmed to, upon selection of the advertising unit by the query client computer, route the query client to an advertising content page associated with the next advertiser in the rotation of participating advertisers retrieved by the query processing section.

16. The computer system recited in claim 15, wherein the query processing section is further programmed to, debit the advertiser the bid denomination associated with the advertising unit.

17. The computer system recited in claim 15, wherein the advertising content associated with the advertiser comprises graphical content displayable on the query client computer as a graphical representation of the advertising unit.

18. The computer system recited in claim 15, wherein the advertising content associated with the advertiser comprises content associated with the website of the next advertiser.

19. A method for providing a pay for performance advertising system on a data network, the method comprising:
maintaining on a computer system having an account database maintained in computer readable media, the account database comprising a plurality of advertising accounts having funds associated therewith and an advertiser database maintained in computer readable media, the advertiser database comprising an advertising unit associated with one or more participating advertisers and bid denominations associated with the participating advertisers;
receiving an advertising unit selection entered on a query client;
retrieving, responsive to said advertising unit selection, a next advertiser in a rotation of participating advertisers associated with said advertising unit, based on the bid denominations of the participating advertisers; and
routing the query client to an advertising content page associated with the next advertiser in the rotation of participating advertisers retrieved by the query processing section.

20. The method recited in claim 19, further comprising debiting the next advertiser retrieved in the step of retrieving based on the bid denomination in the advertising keyword database.

21. The method recited in claim 19, wherein the step of retrieving comprises determining the next advertiser in said rotation of participating advertisers based on historical rotation data of participating advertisers previously retrieved in the step of retrieving and the bid denomination of the participating advertisers.

22. The method recited in claim 19, wherein the step of retrieving comprises determining the next advertiser to reduce a disparity between historical rotation data of the participating advertisers and the bid denomination of the participating advertisers.

23. The method recited in claim 21, wherein the step of retrieving comprises determining historical rotation data comprising actual participation data of each of the participating advertisers.

24. The method recited in claim 21, wherein the step of retrieving comprises determining actual participation data based on a count of the number of times that each participating advertiser is retrieved in the step of retrieving.

25. The method recited in claim 21, wherein the step of retrieving comprises determining target participation data for each of the participating advertisers based on the respective bid denominations.

26. The method recited in claim 25, wherein the step of retrieving comprises determining the next advertiser in said rotation of participating advertisers by reducing the disparity between the actual participation data and the target participation data of each of the participating advertisers.

27. The method recited in claim 19, wherein the step of retrieving comprises determining the next advertiser based on a random number and the bid denomination of the participating advertisers.

28. The method recited in claim 27, wherein the method further comprises generating a random number scaled to the range of the sum of the bid denominations of the participating advertisers, and associating each participating advertiser with a subset of the range corresponding to the respective bid denomination of the respective participating advertiser.

29. The method recited in claim 28, wherein the step of retrieving comprises determining the next advertiser based on a correlation between the random number and the subset of the range corresponding to one of the participating advertisers.

30. The method recited in claim 19, wherein the method further comprises displaying, responsive to an advertising unit selection entered on a query client computer, a listing of a subset of participating advertisers associated with said advertising unit.

31. The method recited in claim 30, wherein the step of displaying further comprises displaying, responsive to an advertising unit selection entered on a query client computer, a listing of all participating advertisers associated with said advertising unit.

32. The method recited in claim 30, wherein the step of displaying further comprises displaying said listing in an order corresponding to the bid denominations associated with the participating advertisers.
